(19) United States
(12) Patent Application Publication
(10) Pub. No.: US 2018/0357653 A1
(43) Pub. Date: Dec. 13, 2018

(54) POTENTIAL INTERVIEWERS RECRUITMENT AND SELECTION SYSTEM, MARKET RESEARCH CONDUCTING METHOD, AND MOBILE ELECTRONIC DEVICE

(71) Applicant: LEAN SURVEY PESQUISAS DE MERCADO LTDA

(72) Inventors: Alessandro Tieppo de ANDRADE, Cerqueira César, São Paulo (BR); Fernando Approbato SALAROLI, Vila Mariana, São Paulo (BR)

(21) Appl. No.: 15/739,079

(22) PCT Filed: Jun. 22, 2016
(86) PCT No.: PCT/BR2016/000062

§ 371 Date: Dec. 21, 2017

(30) Foreign Application Priority Data
Jun. 24, 2015 (BR) 102015015235-3

(51) Int. Cl. G06Q 30/02; G09B 19/18; G09B 5/02; G09B 7/00

(52) U.S. Cl. CPC G06Q 30/0203; G09B 7/00; G09B 5/02; G09B 19/18

(57) ABSTRACT

A potential interviewers recruitment and selection system for market research is disclosed. A method of conducting market research via passersby interview and a mobile electronic device is also described. The system, method and device work together in order to incorporate high-tech combined with the human factor to obtain reliable data and focus on research environment. In the market research conducting method the electronic device carrier goes into the field to interview passersby, delivering the collected data to a central server.

### FIELD OF THE INVENTION

The present invention relates to a tool configured to optimize the work of the market research area professional.

### BACKGROUND OF THE INVENTION

Market research is an essential tool for managers, marketing directors and other decision makers of various business models.

Among other more specific purposes, market research is carried out for:
I. Identifying potential customers;
II. Understanding the consumer profile of a particular product/service;
III. Identifying business opportunities;
IV. Developing improvements and adaptations to existing products or services; and
V. Developing more efficient strategies related to the distribution and promotion of commodities and services;

In the prior art, market research is usually performed in one of the following embodiments:
1) Face-to-face surveys;
2) Online surveys;
3) Telephone surveys; and
4) Surveys via mobile applications with collection of online/offline interviews.

On face-to-face surveys, a interviewers recruitment and selection company conducts a screening of professionals who will be sent to the field to conduct information collection.

The interviewers are often self-employed, who work under informal arrangement and provide occasional services to the recruitment and selection companies.

In this type of survey, the interviewer comes out to the field with a clipboard or a tablet, and interviews dozens of passersby in a particular place (or places) chosen by the recruitment company.

Interviewers recruitment and selection companies do not usually adopt strict methodologies of screening professionals, being commonly recruited those who accept the lowest cash bid for the survey. After hiring the professionals, this workforce is directed to specific courses and training, which require significant time and money by the recruitment company.

In addition to inadequate screening and training costs, this kind of professional can generate labor liability to the recruitment company, given the informal nature of the service. Notwithstanding, this method is incompatible with more effective validation methods, which make use of advanced electronics for information validation.

Usually, in this type of survey, the information validation is ensured by a local manager, in charge of overseeing in person the work of researchers. In addition, some survey institutes have the practice to call a percentage of the interviewee's base, ensuring that the people identified in the survey have been actually interviewed. It turns out that, as the data check is carried out by the own survey institute, there is no guarantee beyond the reputation of the institute that the data received by the final recipient of the survey has been collected with full integrity and seriousness.

The second type of survey listed above, online survey, is commonly conducted via email, by sending an electronic questionnaire to a list of previously cataloged emails in a database.

The online survey is very poor and ineffective. E-mails with online surveys often come up against the spam filter of recipient's e-mails and hardly are viewed by them. Notwithstanding, when viewed, they are rarely answered; and when answered, they are rarely taken seriously and responded with integrity and good faith.

Another downside of this type of survey is the delay in data collection. Even when a very large base of people is searched, the execution time of this kind of survey is quite slow.

The only advantage of online survey is the low cost of implementation.

The telephone survey also finds difficulties similar to the ones faced on online surveys, as it generates unreliable data, and its realization demands a lot of effort from telemarketers, since their phone calls are rarely met or taken seriously by respondents.

Telephone surveys also reveal the aggravation of being more expensive than online survey, as demand contraction of telemarketers for its realization.

Currently most modern existing surveys are the surveys by mobile applications with collection of online/offline interviews.

Surveys by mobile applications with collection of online interviews are displayed, for example, in the following patent applications US20120173305 and US2014/0067474.

This type of survey is interesting because has the ability to filter the profile of the interviewee, intelligently relating the actual survey with the interviewee's characteristics.

However, it is known that, on the rare occasions in which they respond to this kind of survey, users are not interested in responding each one of the surveys directed to them with integrity and sincerity, clicking in the first response that appears in the smartphone screen as soon as possible, independent of this response being in agree or disagree with the user opinion. The human factor, present in the face-to-face survey—but non-existent in survey via mobile application—contributes to a more assertive survey, more suited to the reality of the opinion of the interviewees.

Nevertheless, surveys via mobile applications cover a very limited search range. Hardly a mobile application system comprises all profiles of people needed to perform a given study in its internal register. For this reason, it is very common for these systems to deliver very poor data regarding the statistical efficiency of the survey.

In conclusion, in the prior art, there is no survey method or researchers recruitment which comprises a good screening system of interviewees or researchers, which adds the human factor to the survey, and which does not comprise the drawbacks revealed by traditional face-to-face surveys.

### INVENTION OBJECTIVES

The present invention aims a potential interviewers recruitment and selection system for market research, this system being configured to select only the best suited researchers to a particular type of survey.

The present invention also aims a market research conducting method, which simultaneously employs the use of the human factor and advanced validation technology to increase the reliability of the collected data.

Finally, the present invention also aims a mobile electronic device, configured to enabling above objectives to be achieved.

### BRIEF DESCRIPTION OF THE INVENTION

Objectives of the present invention are achieved by a potential interviewers recruitment and selection system for market research, comprising: at least two mobile electronic devices each associated with a potential interviewer; and at least one central server. The central server being configured to: analyze and determine which are the most qualified among the potential interviewers to perform each survey; and send to each potential interviewer a request to conduct a certain market research.

Objectives of the present invention are also achieved by a market research conducting method via passerby field interview, which is performed by a potential interviewer equipped with a mobile electronic device, the mobile electronic device being provided with a screen and a typing means, the screen being configured to display text messages and the typing means being configured to allow insertion of response data. The potential interviewer being in charge of: (i) go into the field; (ii) read messages displayed on the mobile electronic device screen before a passerby; and NO write down the answers given by passerby via typing means.

Objectives of the present invention are also achieved by a mobile electronic device, equipped with a voice recorder, a GPS, a camera, a screen and a typing means, the mobile electronic device being configured to allow conducting interviews of passersby by the carrier of the mobile electronic device.

### BRIEF DESCRIPTION OF DRAWINGS

The present invention is described in more detail based on the respective figures:

FIG. 1 is a front view of the mobile electronic device of the present invention in a first constructive embodiment;

FIG. 2 is a front view of the mobile electronic device of the present invention in a second constructive embodiment;

FIG. 3 is a previous view of the mobile electronic device of the present invention in its second constructive embodiment;

FIG. 4 is a graphical representation of the recruitment system of the invention; and

FIG. 5 is a graphical representation of the recruitment system of the invention, showing the process of information collection by the interviewers.

### DETAILED DESCRIPTION OF THE INVENTION

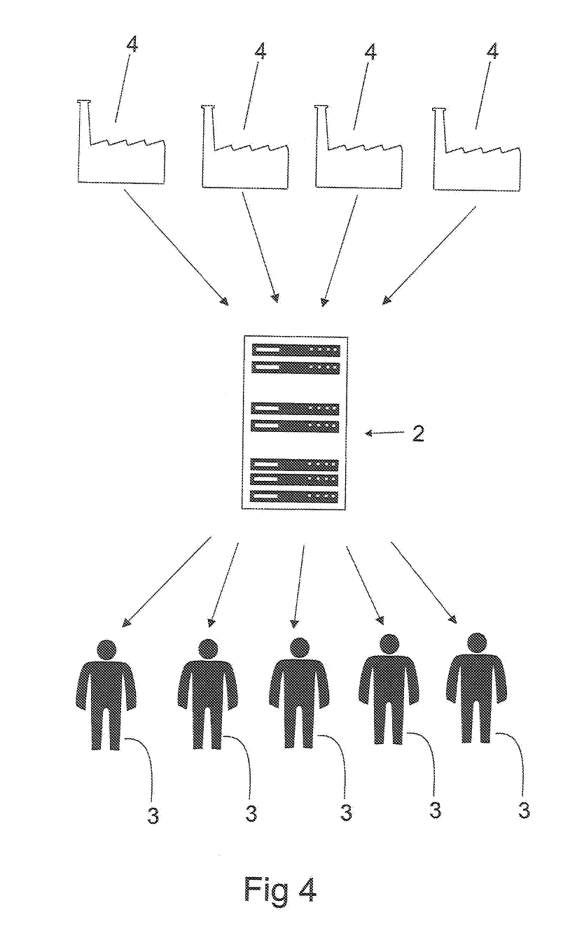

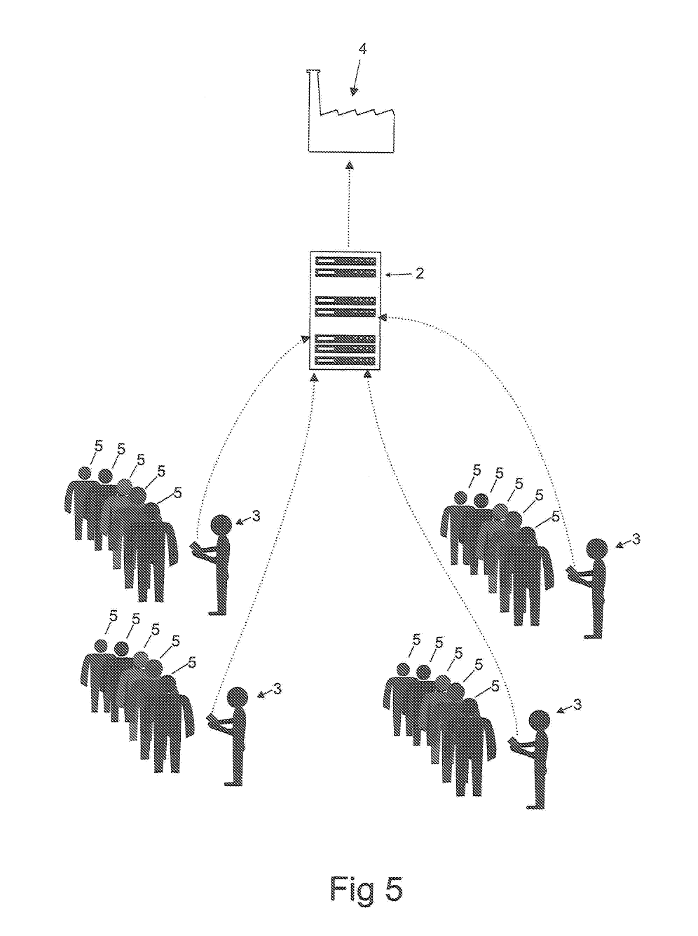

The present invention, as shown in FIG. 4, consists of a potential interviewers recruitment and selection system 3 for conducting market research.

The recruitment and selection system consists of an crowdsourcing electronic system that aims to recruit people to carry out face-to-face surveys with specific focus on environment and population.

By “focus on environment” means: places such as retail outlets, shopping malls, colleges, clubs, neighborhoods, cities, etc.

By “focus on population” means: gender, age, education, marital status, family income, nationality, place of birth, etc.

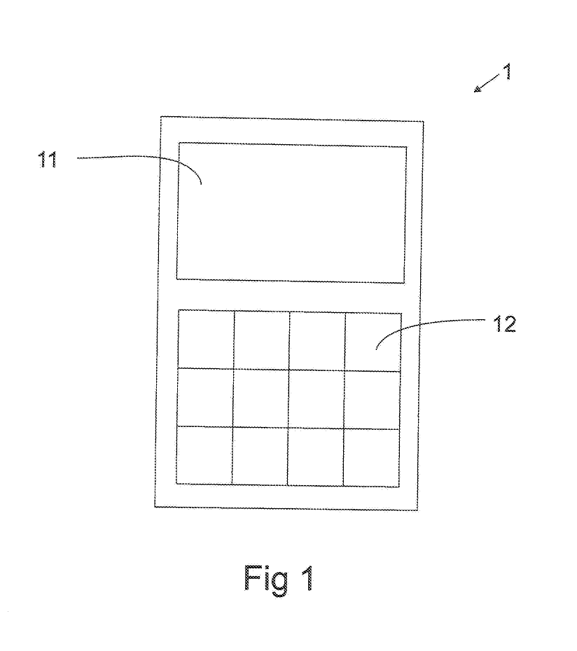

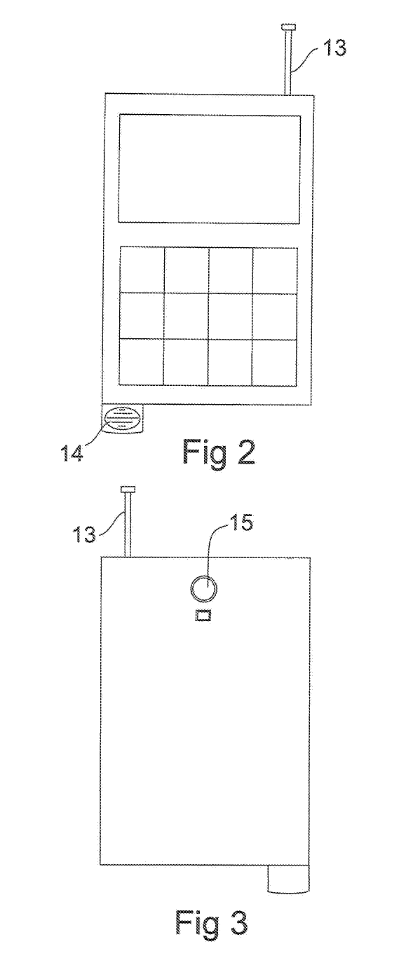

The recruitment is accomplished by use of a mobile electronic device 1, as shown in FIGS. 1, 2 and 3. Alternatively, recruitment can also be accomplished by use of a virtual platform instead of a mobile electronic device 1. Said virtual platform can be, for example, a registration and professional training website,

The mobile electronic device 1 may be a conventional mobile phone, a smartphone, tablet or any other electronic means, portable, comprising at least: a means of transmitting and receiving information 13, an screen 11 to display information; and a means for entering information, preferably, a typing means 12.

Mobile electronic device 1 should communicate with a central server 2, which is configured to:
I. alert potential interviewers 3 when they are selected to perform a given survey;
II. send a specific training to potential interviewer 3 for each survey intended to him/her;
III. carry out an individual assessment for each potential interviewer selected for each survey, based on knowledge obtained in the said training;
IV. send a questionnaire that will work as a support to the survey of potential interviewers 3; and
V. receive and validate the data collected by prospective interviewers 3.

For purposes of defining the scope of the present invention, by central server 2 means: any physical means of electronic processing provided remotely in relation to mobile electronic devices 1, including in this definition: a set of physically separate servers, however operationally connected.

In practice, by the perspective of the potential interviewer 3, the recruitment and selection system of the invention works as follows:
I. the potential interviewer 3 sings up in an online platform, by declaring interested in carrying out surveys;
II. during the registration process, the potential interviewer 3 fills out a form that asks for information which aim establishing a profile for each potential interviewer 3;
III. the potential interviewer 3 receives a generic training, set up to prepare him/her for future work, in this training general survey techniques are taught and is also provided a tutorial on how to navigate through the system;
IV. the potential interviewer 3 answers an assessment referring to the received generic training;
V. being approved by said assessment, if selected by the recruitment and selection system of the invention for a particular survey, the potential interviewer 3 will receive a visual or hearing message on his/her mobile electronic device 1 reporting about his/her approval;
VI. then, the potential interviewer 3 receives a specific training on the survey intended to him/her, followed by a specific assessment for said specific training;
VII. if approved on the specific evaluation, the potential interviewer 3 is called to perform the survey;
VIII. in field, the potential interviewer 3 will interview passersby 5, collecting information from different people based on a questionnaire sent by the server 2;
IX. when all the required information is collected on the field, the potential interviewer 3 will send all the collected information to the central server 2;
X. if the collected responses are validated, the potential interviewer will receive a cash reward.

Regarding the step II, the potential interviewer 3 should answer questions related to the environment where he/her usually passes through, such as: place where studies, place where works, places where he/her goes regularly during the week and weekends; as well as questions related to your personal profile: age, education, marital status, family income, nationality, naturalness, political leaning, religion, etc.

Regarding the generic training, conducted in step III, it is basically composed of videos and institutional texts, which aim to present in a general way how the system of the invention works, and courses in video, text and slide show format, which aim to teach survey techniques.

To validate the collected responses (step X of the above list), a series of validation methods are carried out after the responses are sent to verify the authenticity of the data entered by the potential interviewer 3. These methods Include:
Verification of the survey duration and answers given to each one of the questions (if the duration is too short for a response or for survey as a whole, it is concluded that the researcher has invented the answers);
The audio record of interviews (serves both to audit if the interviewer was talking to someone, but also if the form has been properly completed for a given question in particular);
Use of statistical methods and misleading questions;
The request to obtain photos or videos of where the survey was conducted;
Obtaining geographic coordinates for the survey via GPS device;
Record the completion date and time of each interview; and
Passerby confirmation by SMS.

It is evident that, for audio recording and collection of photos and videos where the survey was conducted, the mobile electronic device 1 should comprise at least one recorder device 14 and a camera 15. To obtain geographic coordinates, the mobile electronic device 1 needs an internal GPS device; and to record the date and time of the interview, it should be comprised in such device, a clock unit and a digital calendar synchronized with a virtual platform which prevents the manipulation of the date and time for the carrier of the mobile electronic device 1.

Alternatively, it may be asked to the passerby 5 (i.e. the interviewed person) that he/she rates the work of the interviewer 3 via text or SMS application after collection of information (a score from 0 to 5, for example, being “5” the best assessment). For this, it will be necessary that the potential interviewer 3 asks the phone number of the passerby 5, at the beginning or the end of the survey, for the system to contact after the interview.

After the end of the interview—after enough time so that the passerby 5 has distanced himself/herself from the interviewer 3—an electronic text or audio message will be automatically sent to the phone carrier, asking the passerby 5 which is the rate for assessment the potential interviewer 3 work:

“Please type a value between zero and four. Type zero means that the work of the potential interviewer was executed in the worst possible way, type 4 if it was executed in the best possible way, type 3 for a regular work.

If you have not been interviewed, type 99.”

If received the highest rate, the potential interviewer 3 receives an extra bonus (i.e. a percentage in addition to the combined value for the survey). If received the signal that did not interview the particular person, the interviewer 3 receives nothing, and suffers a system penalty, being demoted from the interviewer's ranking or deleted permanently from the system database.

From the perspective of companies 4, the recruitment and selection system of the invention works as follows:
I. a company representative 4 accesses a virtual platform declaring interested in conducting a market research for his/her company 4;
II. said representative fills out a form where states the profile of the population that he/she wishes to search (age, gender, income, education, political inclination, etc.);
III. the representative informs the questions that need answers (questionnaire delivery);
IV. the company representative 4 selects in a virtual map one or more PINs where he/she wants the survey to be carried out, stating the minimum and maximum number of responses for each PIN (for “PIN” means a point with X and Y coordinates, arranged in a two-dimensional representation map);
V. representative sets the time and date of the survey and the deadline for submission responses;
VI. then the representative chooses the level of potential interviewers 3 according to the internal ranking obtained with the general and specific evaluations produced by the system;
VII. finally, the representative has the possibility to include specific training for his/her project (this step is necessary when there is the need to indoctrinate the interviewer 3 concerning the definition of certain element addressed in the questions, e.g. a financial product of high complexity).

By company 4, in the context of this specification, means: profit or non-profit legal entities, public or limited companies, NGOs, political parties, government agencies, academic researchers, scientists, candidates for election, among other possible interested in conducting market research.

To the company 4 is provided a platform where it can monitor the collected data on real-time. Said platform comprises filters for question, interviewer, time, date, location, among other data selection and filtering parameters. With this platform the company can also access the interviews audio, videos and photographs taken during survey.

Main advantages of the present invention upon previous techniques are:
A more refined process of selection, recruitment and training of potential interviewers 3;
A method of conducting market research that simultaneously employs the use of the human factor and advanced technology in order to increase the reliability of the collected data.
A shorter feedback time of company 4, through the provision of an online platform, which allows real-time data monitoring, and the achievements of real-time strategy changes, i.e. before the search is complete; and
The provision of auditable digital information, which enables companies 4 to audit themselves the veracity and reliability of the collected data.

About the provision of auditable digital information, it is noted that none of the screening methods known in prior art is able to generate an auditable information. Existing survey methods allow only survey institutes to perform validation and audit data processes. Thus, prior art survey methods create an environment where companies 4 have to blindly trust the name and tradition of the survey institute chosen, without, however, being able to audit themselves the information collected. The system of the present invention is important because it is able to break this paradigm, making it possible to the final recipient of the information, i.e. companies 4, to validate the data by its own.

Nevertheless, the present invention also provides a collection focusing on environment that has never been allowed by the traditional market research conducting methods.

To illustrate how the invention is superior to existing methods of collection, especially regarding survey focused on environment, we need to analyze the following example. Suppose that a particular company 4 consists of a private college. Now suppose that this particular college wants to know if students of another private college (competitor) are satisfied or dissatisfied with the services provided by the latter. Based on current survey methods, as far as this company 4 can make, is to hire conventional researchers and ordain them to the doors of the competitor university to collect information. Besides being unwise (which could result in retaliation of competitor college), this survey certainly would not result in reliable answers and would consume much time and resources until it was completely finished.

This potential interviewers recruitment and selection system allows to overcome quite easily this kind of problem. A college that comprises over 10 thousand students would certainly have one or more of these students enrolled in the system of the present invention. Based on these assumptions, it is assumed that these “one or more students” could easily be recruited to conduct a research within the college where they study, away from the eyes of the directors and administrators of the institution.

Not enough that fact, another advantage of the method of the present invention is the fact that it allows passerby 5 to have the same profile and thus the same language of the interviewer 3. This allows an easier approach to carry out the survey and avoids miscommunication between the interviewer and the interviewee.

The same kind of situation described above, where it is necessary to conduct a survey in a closed environment to the general public, can occur with private leisure clubs, political parties, large companies, or any other means which may be necessary or, at least more convenient, the interviewer 3 is analogous to the interviewee (passerby 5).

For reasons cited, it is understood that the present invention is able to provide a new survey and data collection method that is able to perform an environment focused survey (although the environment is private and closed to the public); able to provide auditable digital data in real time (breaking the need for companies 4 of blindly relying on data provided by survey institutes); that simultaneously employs the use of the human factor and advanced technology in order to increase the reliability of the data collected; and makes use of an intelligent selection, recruitment and training system of potential interviewers 3.

Having described some examples of preferred embodiment of the invention, it is noteworthy that the scope of protection conferred by this document encompasses all other alternative forms appropriate to the implementation of the invention, which is defined and limited only by the set of claims content attached.

1. A recruitment and selection system, comprising:
at least two mobile electronic devices each associated with a potential interviewer;
at least one central server;
the central server being configured to:
analyze and determine from the potential interviewers, which are the most qualified to perform each survey; and
send to each potential interviewer a request to perform a certain market research corresponding to a survey.

2. The recruitment and selection system of claim 1, wherein the system selects interviewers based on a profile and a geolocation of at least one of the following places frequented by the interviewers:
place where interviewers study;
place where interviewers work;
places where interviewers go regularly during the week; and/or
places where interviewers go regularly during the weekend.

3. The recruitment and selection system of claim 1, wherein the central server analyzes potential interviewers based on a profile completed by potential interviewers in an online platform.

4. The recruitment and selection system of claim 3, wherein among the profile data of potential interviewers are: gender, age, education, marital status and family income.

5. The recruitment and selection system of claim 1, wherein the central server is configured to send a specific training for each potential interviewer, the specific training being related to market research assigned to the potential interviewer.

6. The recruitment and selection system of claim 5, wherein after sending of specific training, an assessment of the potential interviewer knowledge is carried out.

7. The recruitment and selection system of claim 5, wherein the central server sends a questionnaire to the mobile electronic device associated to the chosen potential interviewer.

8. The recruitment and selection system of claim 7, wherein the central server performs a data check on collected data of a particular potential interviewer being able to identify errors and manipulations in answers inserted in the mobile electronic device.

9. The recruitment and selection system of claim 8, wherein among the collected data by the central server for response validation purposes are:
audio interviews record;
obtaining geographic coordinates for the research;
interview time registration; and
assessment by passerby.

10. A method of conducting market research via passerby interview, comprising:
displaying messages on a mobile electronic device, the mobile electronic device being provided with a screen and an input device, the screen being configured to display the messages and the input device being configured to allow input of data;
receiving, at the input device of the mobile electronic device, input of an answer to each message from an interviewee.

11. The method of conducting market research of claim 10, further comprising receiving input of the interviewee's phone number.

12. The method of conducting market research of claim 10, wherein the mobile electronic device comprises at least one recording device configured to enable audio recording of the answers given by the interviewee.

13. The method of conducting market research of claim 10, wherein the mobile electronic device comprises at least one GPS device configured to record the geographical coordinates of the location of the mobile device during the interview.

14. The method of conducting market research of claim 10, wherein the mobile electronic device comprises at least one camera configured to allow the image capturing of the location where the survey is performed.

15. A mobile electronic device comprising a recorder, a GPS, a camera, a screen and an input device, wherein the mobile electronic device is configured to perform the method of claim 10.
